(19) United States
(12) Patent Application Publication
(10) Pub. No.: US 2013/0080738 A1
(43) Pub. Date: Mar. 28, 2013

(54) PROCESSOR CONFIGURED TO PERFORM TRANSACTIONAL MEMORY OPERATIONS

(71) Applicants: Erich J. Plondke, Austin, TX (US); Ajay A. Ingle, Austin, TX (US); Lucian Codrescu, Austin, TX (US)

(72) Inventors: Erich J. Plondke, Austin, TX (US); Ajay A. Ingle, Austin, TX (US); Lucian Codrescu, Austin, TX (US)

(73) Assignee: QUALCOMM INCORPORATED, San Diego, CA (US)

(21) Appl. No.: 13/241,775

(22) Filed: Sep. 23, 2011

(51) Int. Cl. G06F 15/76; G06F 9/312; G06F 9/06

(52) U.S. Cl. 712/24; 712/E09.003; 712/E09.033

(57) ABSTRACT

In a particular embodiment, a very long instruction word (VLIW) processor is operable to execute VLIW instructions. At least one of the VLIW instructions includes a first load or store instruction and a second load or store instruction. The first instruction and the second instruction are executed as a single atomic unit. At least one of the first and second instructions is a store-conditional instruction.

### I. FIELD

The present disclosure is generally related to a processor operative to perform memory operations.

### II. DESCRIPTION OF RELATED ART

Advances in technology have resulted in smaller and more powerful computing devices. For example, there currently exist a variety of portable personal computing devices, including wireless computing devices, such as portable wireless telephones, personal digital assistants (PDAs), and paging devices that are small, lightweight, and easily carried by users. More specifically, portable wireless telephones, such as cellular telephones and internet protocol (IP) telephones, can communicate voice and data packets over wireless networks. Further, many such wireless telephones include other types of devices that are incorporated therein. For example, a wireless telephone can also include a digital still camera, a digital video camera, a digital recorder, and an audio file player. Also, such wireless telephones can process executable instructions, including software applications, such as a web browser application, that can be used to access the Internet. As such, these wireless telephones can include significant computing capabilities.

An electronic device, such as a wireless telephone, may include multiple requestors (e.g. threads of a multithreaded processor or multiple processors) that share a resource (e.g. a data structure in memory). For example, a plurality of requestors (e.g. readers and writers) may use a first-in, first-out (FIFO) data structure to temporarily store data. A write index may point to a next available entry of the FIFO data structure (e.g. so that threads or processors of the electronic device may know where to write data at the FIFO data structure).

However, a problem may arise when the data and the write index corresponding to the data are updated independently. For example, if the data is updated before the write index, then another writer operating concurrently could overwrite the data location. Conversely, if the write index is updated before the data, then a concurrent reader may attempt to read the data that has not been written yet. Hence, it may be desirable to update both the data and its corresponding write index entry atomically, i.e. as part of the same memory transaction.

### III. SUMMARY

Various techniques may be implemented to allow both the data and the write index to be updated atomically. For example, all or part of the structure may be locked, so that only one writer at a time may modify the data structure. However, the lock may limit concurrency, causing performance bottlenecks. To overcome these bottlenecks, “lock free” algorithms may be used to update data structures concurrently without acquiring locks.

Processors may use an atomic read-modify-write operation, which can implement locks, as well as “lock free” algorithms. However, some lock free algorithms may require atomic execution of multiple concurrent memory operations. Some architectures have developed schemes to allow multiple memory operations to happen atomically. For example, a partial-commit instruction may record information about a proposed operation and thereafter decide whether or not the operation should be completed. If it is determined that the operation should not be completed (e.g. due to an exception, modification by another processor or thread, or other event causing failure), portions of the operation already performed may be “rewound” (i.e. undone). If it is determined that the operation should be completed, all updates within the transaction may be “committed” (i.e. written to memory). This is sometimes known as “transactional memory.”

Transactional memory systems may not always be desirable. For example, transactional memories may have high cost, with additional memory, bus, cache, and processor complexity to support the transaction protocol.

An atomic update of a memory location may involve a particular load of a value stored at the memory, referred as a load-locked operation. After modifying the value, a second operation may be used, which stores the modified value if no other processor or thread has modified it since the value was loaded. This may be known as store-conditional. A transactional memory operation may atomically execute a plurality (e.g. two) of store-conditional operations. Execution of the plurality of instructions results in either success or failure of the operations (e.g. if any of the store-conditional memory operations fails then the plurality of instructions is deemed to have failed). It should be noted that as used herein, two operations may be considered “atomically executed” if the operations have an all-or-nothing relationship, i.e. either both operations succeed or both operations fail. Further, as used herein, two operations may be “atomically linked” in that they may be encapsulated in a single packet and therefore executed simultaneously and indivisibly. Thus, “atomically linked” operations may also be referred to as being “grouped” or “packetized.”

In another particular embodiment, a very long instruction word (VLIW) processor is operable to execute VLIW instructions, at least one of the VLIW instructions including a first load or store instruction and a second load or store instruction. The first instruction and the second instruction are executed as a single atomic unit. At least one of the first and second instructions is a store-conditional instruction.

In another particular embodiment, a computer-implemented method includes executing a program that includes a transactional memory operation. The transactional memory operation includes a first memory operation atomically linked to a second memory operation. The first and second memory operations are identified by a single VLIW packet for execution at a VLIW processor.

In another particular embodiment, an apparatus includes a multithreaded processor including a load/store unit. The load/store unit includes multiple address reservation registers assigned to each thread. Each of the address reservation registers stores a reserved address associated with a load-locked store-conditional pair of operations and may further store a valid bit that indicates whether data at the reserved address has changed. A success or a failure associated with the pair of instructions may be based on whether the data associated with one or more of the pair of instructions has changed (e.g. based on whether the valid bit indicates that the data has changed).

In another particular embodiment, an apparatus comprises means for executing very long instruction word (VLIW) instructions, wherein at least one of the VLIW instructions includes a first load or store instruction and a second load or store instruction, wherein the first instruction and the second instruction are atomically executed as a single atomic unit, and wherein at least one of the first and second instructions is a store-conditional instruction. The apparatus further comprises means for storing data, wherein the means for storing data is responsive to the means for executing VLIW instructions.

In another particular embodiment, a computer-readable tangible medium stores instructions executable by a computer to execute a program that includes a transactional memory operation. The transactional memory operation includes a first memory operation atomically linked to a second memory operation, wherein the first and second memory operations are executed by a single very long instruction word (VLIW) packet at a VLIW processor.

In another particular embodiment, an apparatus includes a VLIW processor. The VLIW processor has a buffer including a plurality of data entries, a write index operable to selectively point to each of the plurality of data entries, and a load/store unit. The load/store unit executes a pair of load-locked operations as a single atomic unit and also executes a pair of store-conditional operations as a single atomic unit.

One particular advantage provided by at least one of the disclosed embodiments is a VLIW processor that is operative to perform concurrent atomic memory operations. For example, multiple threads of the VLIW processor may share a resource (e.g. a data structure) without locking the resource and without blocking the threads from accessing the resource. Accordingly, use of the resource may become less restricted, since all threads may be permitted to use the resource.

Another particular advantage provided by at least one of the disclosed embodiments is a VLIW processor that is operative to perform memory operations without first recording information regarding the memory operations. For example, a traditional transactional memory may use a partial-commit instruction, in which information about a proposed memory operation is recorded prior to determining whether or not the proposed memory operation should be performed. A transactional memory in accordance with the present disclosure may execute first and second instructions substantially in parallel (e.g. without determining whether the second instruction should be performed based on a result of executing the first instruction). Yet another advantage provided by at least one of the disclosed embodiments is a transactional memory that is supported within a core chip (e.g. without external circuitry such as a cache, bus, or memory support).

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of a particular illustrative embodiment of an apparatus that executes instructions as a single atomic unit;

FIG. 2 is a block diagram of a particular illustrative embodiment of a load/store unit of the apparatus of FIG. 1;

FIG. 3 is a diagram of a particular illustrative embodiment of operation of load/store units of the apparatus of FIG. 1;

FIG. 4 is a flow chart of a particular illustrative embodiment of a method of executing pairs of VLIW instructions; and

FIG. 5 is a block diagram of an electronic device including a processor that includes load/store units of the apparatus of FIG. 1.

### V. DETAILED DESCRIPTION

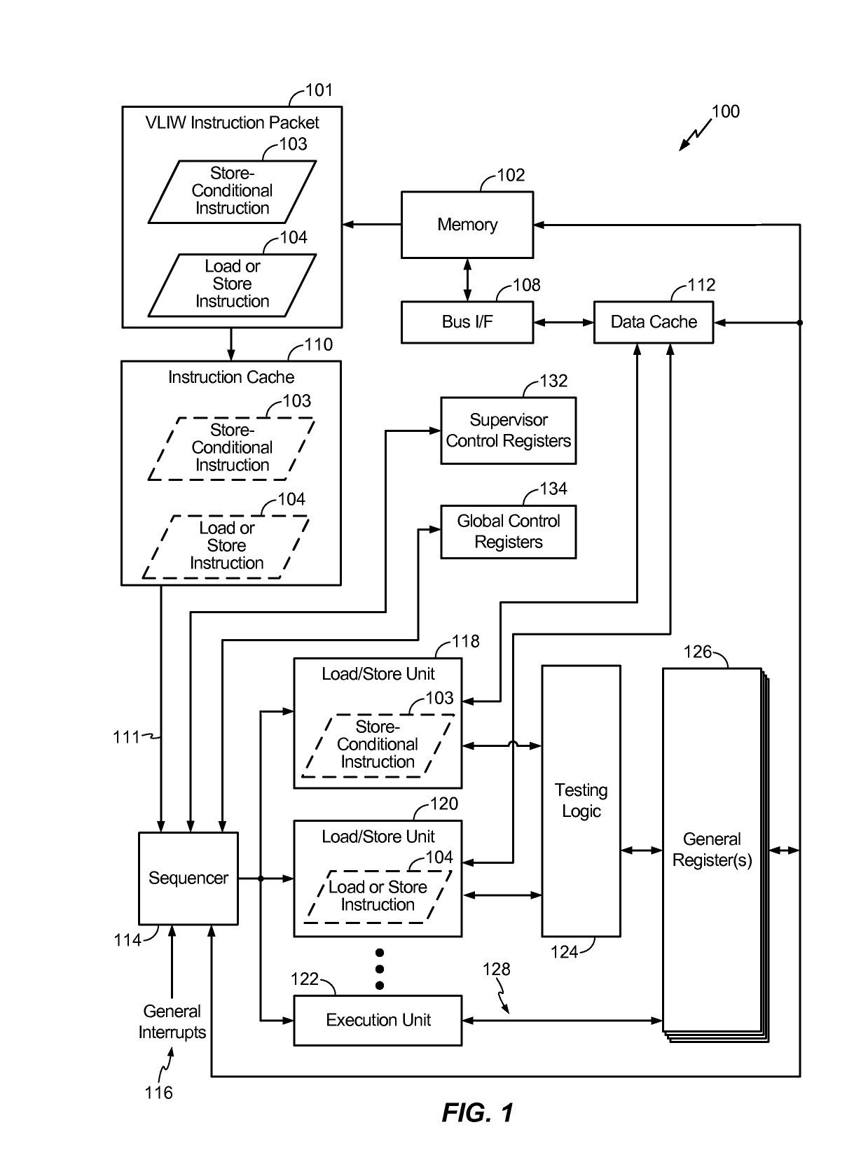

Referring to FIG. 1, a particular illustrative embodiment of an apparatus that is operable to execute multiple instructions as a single atomic unit is shown and generally designated 100. The apparatus 100 includes an instruction cache 110, a sequencer 114, a memory 102, a first load/store unit 118, a second load/store unit 120, an execution unit 122, testing logic 124, and a general register(s) (e.g. a register file) 126 as illustrated.

The apparatus 100 further includes a bus interface 108 and a data cache 112.

The memory 102 is coupled to the bus interface 108. In addition, the data cache 112 is coupled to the bus interface 108. Data may be provided to the data cache 112 or to the memory 102. The data stored within the data cache 112 may be provided via the bus interface 108 to the memory 102. Thus, the memory 102 may retrieve data from the data cache 112 via the bus interface 108.

The apparatus 100 further includes supervisor control registers 132 and global control registers 134. The sequencer 114 may be responsive to data stored at the supervisor control registers 132 and the global control registers 134. For example, the supervisor control registers 132 and the global control registers 134 may store bits that may be accessed by control logic within the sequencer 114 to determine whether to accept interrupts, such as general interrupts 116, and to control execution of instructions.

In a particular embodiment, the apparatus 100 is an interleaved multithreaded processor. The instruction cache 110 may be coupled to the sequencer 114 via a plurality of current instruction registers, which may be associated with particular threads of the interleaved multithreaded processor.

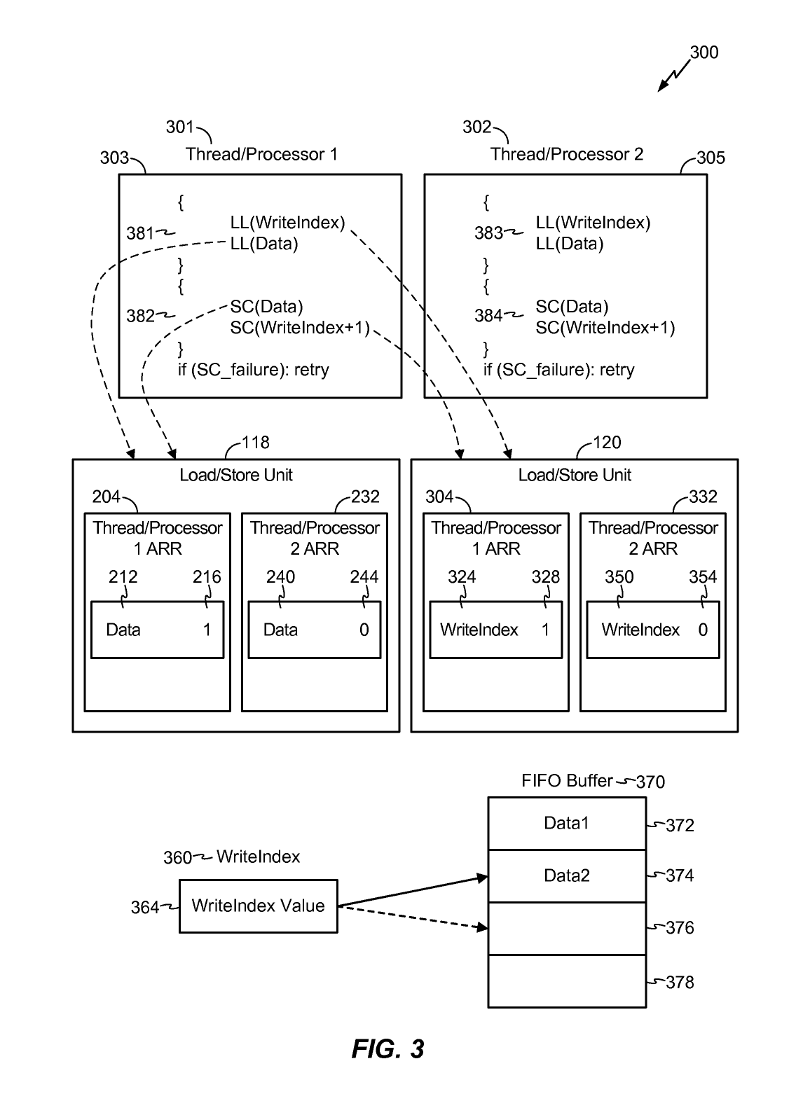

One or more of the memory 102, the general register(s) 126, and the data cache 112 may be shared between multiple requestors, e.g. multiple threads of a multithreaded processor or multiple processors of a multiprocessor system. In a particular embodiment, one or more of the memory 102, the general register(s) 126, and the data cache 112 include a first-in, first-out (FIFO) buffer and a WriteIndex configured to point to a next available data entry of the FIFO buffer, as will be described further with reference to FIG. 3.

During operation, very long instruction word (VLIW) instruction packets, such as the illustrated VLIW instructions packet 101, may be retrieved from the memory 102 and provided to the instruction cache 110. As shown in FIG. 1, the VLIW instruction packet 101 includes a store-conditional instruction 103 and a load or a store instruction 104. The VLIW instruction packet 101 may be stored within the instruction cache 110 and may be retrievable by the sequencer 114, e.g. via an input 111.

In addition to retrieving the VLIW instruction packet 101, the sequencer 114 may respond to the general interrupts 116 and to other inputs. The sequencer 114 may route VLIW instructions or individual instructions, such as the instructions 103-104, to the execution units. According to a particular illustrative embodiment, the VLIW instruction packet 101 may include data that indicates to the sequencer 114 whether to route each instruction in the VLIW instruction packet 101 for parallel or serial execution.

For example, as depicted in FIG. 1, a store-conditional instruction 103 within the VLIW instruction packet 101 is routed by the sequencer 114 to a first load/store unit 118 and the load or a store instruction 104 is routed by the sequencer 114 to a second load/store execution unit 120. It should be understood that while two load/store execution units 118 and 120 are shown in FIG. 1, the apparatus 100 may include additional load/store units and other types of execution units, such as arithmetic logic units, or other representative execution units, such as the execution unit 122.

After execution by the first load/store unit 118 and the second load/store unit 120, outputs of the executed instructions are provided to the testing logic 124. For example, an output of the first load/store unit 118 is provided to a first input of the testing logic 124, and an output of the second load/store unit 120 is provided to a second input of the testing logic 124. In addition, outputs of other execution units, such as the illustrated execution unit 122, may be provided as an execution unit output 128 that is received as an additional input to the general register(s) 126.

The testing logic 124 includes logic to determine whether a condition associated with the store-conditional instruction 103 is successful. For example, the testing logic 124 may include embedded logic to determine whether the store-conditional instruction 103 has succeeded or has failed. In addition, based on the determination of success or failure of the store-conditional instruction 103, the output of the load or store instruction 104 may be selectively discarded or may be provided as an output to the general register(s) 126. Thus, the testing logic 124 may enable atomic execution of the multiple instructions 103 and 104 within the VLIW packet 101.

Atomically executing the instructions 103-104 may involve either executing both instructions completely or executing neither instruction. For example, either both of a first memory operation (e.g. the store-conditional instruction 103) and a second memory operation (e.g. load or store instruction 104) succeed or both of the first and second memory operations fail. In addition, atomically executing the instructions may include generating at least one output that indicates success or failure associated with the store-conditional instruction 103. For example, the testing logic 124 may generate at least one output that indicates success or failure of the tested store-conditional instruction 103. In a particular illustrative embodiment, the at least one output that indicates success or failure is a single bit.

Upon successful execution of the store-conditional instruction 103, the testing logic 124 may provide to the general register(s) 126 an output that indicates a result of executing both the first memory instruction 103 and the second memory instruction 104. In a particular illustrative embodiment, the general register(s) 126 is written to during a write-back stage of a multithreaded operation. The results of execution of the operations are stored within the general register(s) 126 and may be provided upon request to the memory 102. Thus, multiple instructions within a VLIW instruction packet 101 may be executed atomically as a single atomic unit and as part of a single memory transaction (e.g. execution of multiple instructions may be associated with a single success or a single failure).

The apparatus 100 may include a VLIW processor operable to execute VLIW instructions. For example, the VLIW processor may include multiple execution elements, such as the sequencer 114, one or more of the execution units 118-122, and optionally the testing logic 124. In addition, the VLIW processor may include the instruction cache 110 that is configured to store multiple VLIW instruction packets prior to execution. In a particular embodiment, at least one of the VLIW instructions includes a first load or store instruction (e.g. the store-conditional instruction 103) and a second load or store instruction (e.g. a load instruction or a store instruction 104). The first instruction and the second instruction may be executed as a single atomic unit, and at least one of the first and second instructions is a store-conditional instruction. For example, with reference to FIG. 1, the first instruction 103 is a store-conditional instruction. Although the first instruction 103 is shown as a store-conditional instruction, it should be understood that the first instruction may instead be a load or a store instruction (e.g. a load instruction, a store instruction, a load-lock instruction, or a store-conditional instruction), while the second instruction is a store-conditional instruction.

The apparatus 100 provides a means for executing VLIW instructions and a means for storing data, the means for storing data responsive to the means for executing VLIW instructions. For example, the means for executing VLIW instructions may include the VLIW processor as described and the means for storing data may include one or more of the memory elements described, such as the general register(s) 126, the memory 102, and the data cache 112.

As will be appreciated, the apparatus 100 of FIG. 1 may enable atomic execution of instructions, such as the store-conditional instruction 103 and the load or store instruction 104, without locking memory locations corresponding to the instructions. In particular, the instructions may be executed as a single atomic unit. Executing the instructions as a single atomic unit may allow multiple requestors (e.g. threads of a multithreaded processor) of a resource (e.g. a shared data structure in the memory 102, which may be cached by the data cache 112) to efficiently share the resource without waiting during one or more processor cycles for a lock to be released or for access to be granted.

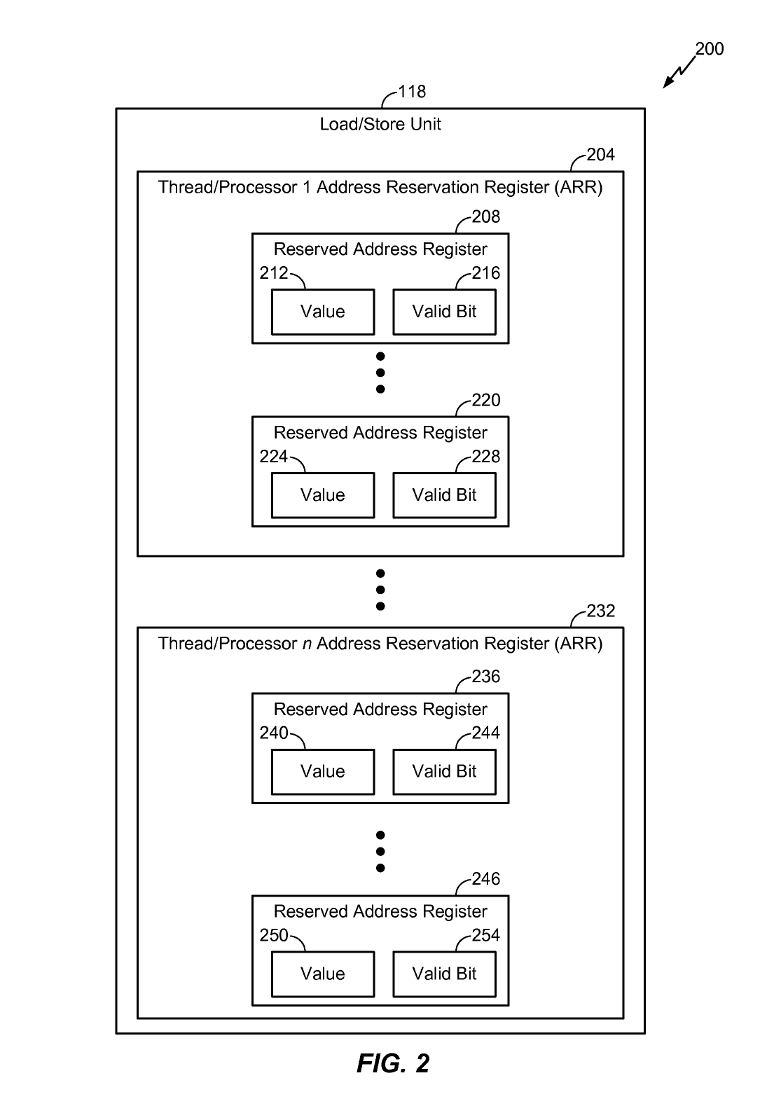

Referring to FIG. 2, a particular illustrative embodiment of the first load/store unit 118 of the apparatus 100 is shown. The load/store unit 118 includes a first address reservation register (ARR) 204 assigned to a first thread or processor. The load/store unit 118 may include additional ARRs. For example, the first load/store unit 118 includes a representative second ARR 232.

Each ARR assigned to a particular thread or processor (e.g. the first ARR 204) may include one or more reserved address registers. For example, the first ARR 204 includes a representative first reserved address register 208 and a second reserved address register 220. The first reserved address register 208 may include a first value 212 and a first representative valid bit 216. Similarly, the second reserved address register 220 may include a second representative value 224 and a second representative valid bit 228.

Similarly, the second ARR 232 may include a first reserved address register 236 that includes a first value 240 and a first valid bit 244. The second ARR 232 may further include a second reserved address register 246 that includes a second value 250 and a second valid bit 254. Thus, each of the ARRs assigned to a particular thread or processor may include multiple reserved address registers. In addition, each of the reserved address registers may include a data value (e.g. an address of a memory location to be monitored) as well as a valid bit stored within the address register and associated with the data value.

In a particular embodiment, an apparatus includes a multithreaded processor that includes a load/store unit. For example, as illustrated in FIG. 1, the apparatus 100 includes a multithreaded processor having a representative load/store unit 118. The load/store unit 118 includes multiple address reservation registers assigned to each thread. For example, the reserved address registers 208 and 220 are assigned to a first representative thread via the first ARR 204.

Each reserved address register may be operable to store a reserved address associated with a load-locked store-conditional pair of operations. For example, the value 212 within the first reserved address register 208 may represent a reserved address that is associated with a load-locked store-conditional pair of operations to be executed by a VLIW processor (e.g. within the apparatus 100). As a particular example, a first instruction of the load-locked store-conditional pair of operations may be a conditional instruction and a second instruction of the load-locked store-conditional pair of operations may be a load-locked instruction. Each of the instructions in the pair of operations may be load-locked such that a value associated with the first instruction is reserved by a requestor (e.g. a thread or processor).

To implement the load-locked operation, the reserved address register 208 includes the first valid bit 216 which may be checked by the requestor (e.g. a processor) prior to making changes to a stored data value (e.g. a memory address) identified by the address contained within value 212. The valid bit 216 may indicate whether or not the address identified by the value 212 has been used in a write operation since the value 212 was set in the first reserved address register 208 (e.g. when a memory location corresponding to the value 212 was reserved by the requestor).

In another particular embodiment, the processor is included in a multiple processor architecture and each of the multiple processors includes multiple address reservation registers. In this embodiment, each of the ARRs 204, 232 is assigned to a separate and independent processor of the multiple processor architecture. Alternatively, as described, each of the ARRs 204, 232 may be assigned to a particular thread of a multithreaded architecture.

Checking an ARR may be performed prior to completing a load-locked store-conditional pair of operations. The checking process may include determining whether data corresponding to one of the ARRs has changed (e.g. by determining a value of a valid bit). In addition, the load-locked store-conditional pair of operations may fail in response to determining that the data corresponding to only one of the ARRs has changed (e.g. determining that data corresponding to one of the ARRs has changed may be sufficient to determine that the load-locked store-conditional pair of operations has failed).

In a particular embodiment, in response to an indication of execution success, at least one memory location of the VLIW processor is updated with data corresponding to the store-conditional instruction. In response to an indication of execution failure, the at least one memory location of the VLIW processor is not updated with the data corresponding to the store-conditional instruction. For example, a write-back stage accepting data output by the testing logic 124 may selectively write results associated with execution of the store-conditional instruction to a register file. Upon indicating execution success, at least one memory location within the general register(s) 126 may be updated, whereas upon an indication of failure the memory location within the general register(s) 126 may not be updated. Thus, the testing logic 124 may selectively write results of executing various instructions depending on the result of testing logic evaluation of the store-conditional instruction 103. Thus, the testing logic 124 together with the general register(s) 126 may be used to atomically execute multiple memory operations issued by a single VLIW instruction packet, and the atomic execution of multiple memory operations within a single VLIW instruction packet may be performed within the context of execution units of a VLIW multithreaded processor architecture or a multiple processor architecture.

It will be appreciated that the load/store unit 118 of FIG. 2 may enable each requestor of a resource to determine whether the resource has been changed by another requestor. In particular, a reserved address and a corresponding valid bit may be stored at an ARR assigned to each requestor. A requestor that reserves the memory location (e.g. by storing an address of the memory location as a value of an ARR) may determine whether or not the memory location has been changed (e.g. overwritten) by another requestor by referencing the valid bit. For example, if the memory location has been changed, then the requestor that reserved the memory location may decide that the reserved memory location contains updated data and that the previous data is no longer valid. In particular, if the memory location has changed, then execution of an operation may be considered to have failed and may be retried later. Accordingly, multiple requestors may share access to a resource without restricting access to the resource (e.g. without locking the resource).

Referring to FIG. 3, a particular illustrative embodiment of an apparatus 300 that includes a multithreaded processor or a multiple processor architecture is shown. The apparatus 300 includes one or more very long instruction word (VLIW) processors, a first in, first out (FIFO) buffer 370, a WriteIndex 360, and at least one load/store unit 118. The apparatus 300 may include multiple load/store units, such as the illustrated first load/store unit 118 and a second load/store unit 120. It should be understood that more than two load/store units may be embedded within the apparatus 300. In addition, the FIFO buffer 370 and the WriteIndex 360 may correspond to a memory resource (e.g. one or more of the general register(s) 126, the data cache 112, and the memory 102 of FIG. 1) that is shared between multiple requestors (e.g. threads of a multithreaded processor or processors of a multiprocessor architecture).

The FIFO buffer 370 includes a plurality of data entries such as a first data entry 372 and a second data entry 374. The WriteIndex 360 is operable to selectively point to each of the plurality of data entries. For example, the WriteIndex value 364 (as shown) initially points to (e.g. stores an address associated with) the second data entry 374 but may selectively point to other data entries of the FIFO buffer 370, such as a third data entry 376 or a fourth data entry 378. In a particular illustrative embodiment, the WriteIndex value 364 indicates a next available data entry of the FIFO buffer 370.

The load/store unit 118, corresponding to the load/store unit 118 of FIG. 1, may be operable to execute a pair of load-locked operations as a single atomic unit and further operable to execute a pair of store-conditional operations as a single atomic unit. For example, a representative first pair of load-locked operations 381 is shown as including a load-locked WriteIndex instruction and a load-locked data instruction (i.e. a LL(WriteIndex) instruction and a LL(data) instruction, as shown in FIG. 3) within the executable program 303 of the first thread or processor 301. As a further example, a store-conditional data instruction and a store-conditional WriteIndex instruction (i.e. an SC(data) instruction and an SC(WriteIndex+1) instruction, as shown in FIG. 3) of the executable program 303 form a representative first pair of store-conditional operations 382.

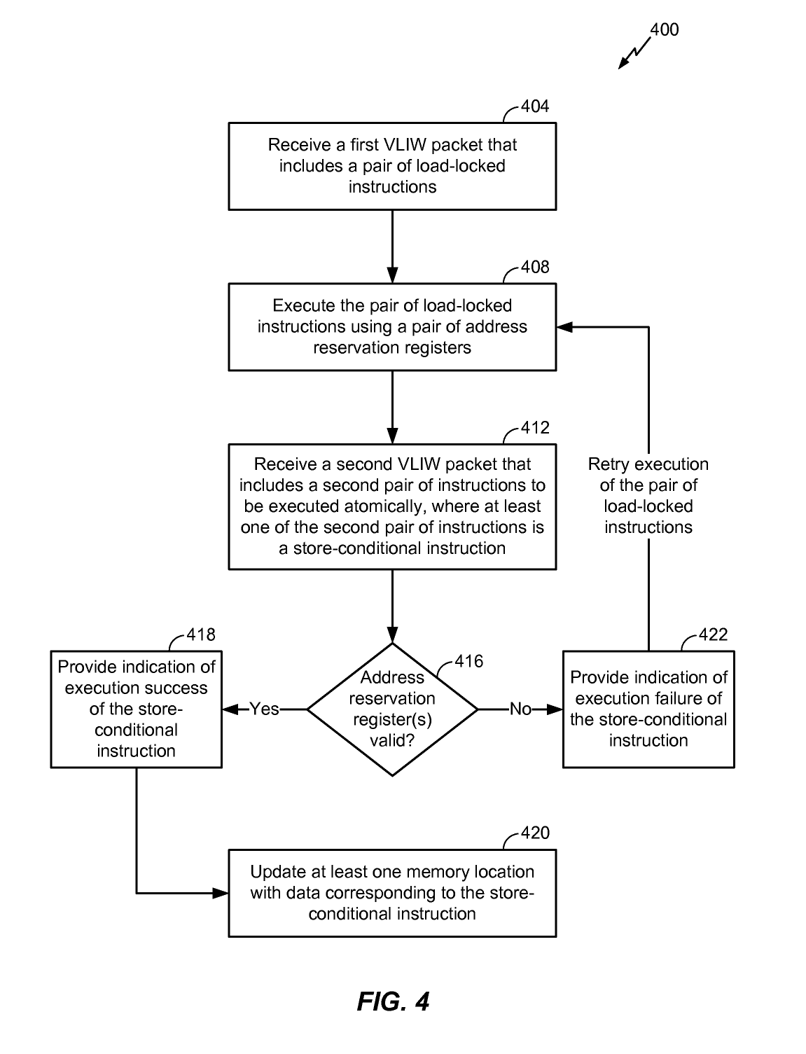

In operation, the first thread or processor 301 may receive the executable program 303 that includes the first pair of load-locked operations 381. For example, the first thread or processor 301 may receive the executable program 303 from the memory 102 of the apparatus 100 of FIG. 1. In response, the first thread or processor 301 may load-lock the WriteIndex 360 and load-lock a next available data entry (e.g. the second data entry 374). That is, the first ARR 204 and the third ARR 304, which correspond to the first thread or processor 301 and which may reserve memory addresses responsive to the first thread or processor 301, may reserve an address corresponding to the second data entry 374 and an address corresponding to the WriteIndex 360 (illustrated by the broken lines in FIG. 4).

Valid bits associated with the first pair of load-locked operations may be generated responsive to the first thread or processor 301 reserving the next available data entry. For example, the valid bit 216 and the valid bit 328 may be initially set. In a particular illustrative embodiment and as depicted in FIG. 3, valid bits are initially set to “1,” as illustrated. In another particular illustrative embodiment, valid bits are initially set to “0.” Thus, it will be appreciated that in the particular illustrative embodiment of FIG. 3, the first thread or processor 301 has reserved a next available data entry via the first ARR 204 and the third ARR 304.

In a particular illustrative embodiment, the second thread or processor 302 may receive the executable program 305 that includes a second pair of load-locked operations 383. In response, the second thread or processor 302 may load-lock the WriteIndex 360 and load-lock a next available data entry (e.g. the second data entry 374). The second ARR 232 and the fourth ARR 332, which correspond to the second thread or processor 302 and which may reserve memory addresses responsive to the second thread or processor 302, may reserve an address corresponding to the second data entry 374 and an address corresponding to the WriteIndex 360

Valid bits associated with the second pair of load-locked operations may be generated responsive to the second thread or processor 302 reserving the next available data entry (which may still be the second data entry 374). For example, the valid bit 244 and the valid bit 354 may be set initially to “1.” Thus, it will be appreciated that the first thread or processor 301 and the second thread or processor 302 have each reserved a next available data entry of the FIFO buffer 370. As described further below, a potential conflict created by multiple requestors (e.g. the first thread or processor 301 and the second thread or processor 302) attempting to access a same resource (e.g. the FIFO buffer 370 and the WriteIndex 360) may be avoided.

After executing the first pair of load-locked operations 381, the first thread or processor 301 may attempt to execute the first pair of store-conditional operations 382. The first thread or processor 301 may reference the valid bits 216, 328 to determine whether the first pair of store-conditional operations can be completed successfully. For example, if any of the valid bits 216, 328 has changed value since the first pair of load-locked operations 381 was executed, the first pair of store-conditional operations may fail and an output may be generated in response that indicates the failure of the first pair of store-conditional operations 382.

If none of the valid bits 216 and 328 have changed since the first pair of load-locked operations 381 was executed, then the first pair of store-conditional operations 382 is successfully committed. For example, the second data entry 374 may be populated with data (e.g. written with Data2 as shown in FIG. 3) and the WriteIndex value 364 may be incremented to point to the next available data entry of the FIFO buffer 370 (e.g. to the third data entry 376 as shown by the dashed line in FIG. 3). An output may be generated that indicates the success of the first pair of store-conditional instructions 382. In a particular illustrative embodiment, the output is a single bit that is provided to the first thread or processor 301 so that the first thread or processor 301 may determine the success or failure of the first pair of store-conditional instructions 382.

In response to populating the second data entry 374 and updating the WriteIndex value 364, the valid bits 244, 354 may be changed to reflect that a requestor (i.e. the first thread or processor 301) has written to the second data entry 374 and updated the WriteIndex value 364. For example, the first thread or processor 301 may include circuitry operable to clear (e.g. reset to “0”) any valid bits that were set in response to the first load-locked pair of operations 382. Accordingly, the valid bits 244, 354 may be changed to a “0” value, as depicted in FIG. 3. For example, the first thread or processor 301 may change the valid bits 244, 354 to a “0” value to reflect that the first thread or processor 301 has written to the second data entry 374 and has updated the WriteIndex value 364 to point to a new next available data entry of the FIFO buffer 370.

Continuing with the example operation of the apparatus 300, the second thread or processor 302 may attempt to execute a second pair of store-conditional operations 384 after executing the second pair of load-locked operations 383 and after the first thread or processor 301 has executed the first pair of store-conditional operations 382. The second thread or processor 302 may reference the valid bits 244, 354 to determine whether the second pair of store-conditional operations 384 can complete successfully. With respect to the example operation described, the second thread or processor 302 may determine that the second pair of store-conditional operations 384 has failed because one or more of the valid bits 244, 354 have changed since the second pair of load-locked operations 383 was completed.

In response to the failure of the second pair of store-conditional operations 384, the second thread or processor 302 may later retry execution of the executable program 305. For example, the second thread or processor 302 may later re-execute the second pair of load-locked operations 383 and the second pair of store-conditional operations 384. The subsequent execution of the executable program 305 may enable the second thread or processor 302 to write data to the FIFO buffer 370 without overwriting data written to the FIFO buffer 370 by the first thread or processor 301 (i.e. the Data2 written to the second data entry 374).

As will be appreciated, the apparatus 300 of FIG. 3 may facilitate sharing of resources (e.g. the FIFO buffer 370 and the WriteIndex 360) by multiple requestors (e.g. the first thread or processor 301 and the second thread or processor 302). The resources may be shared without locking the resources, since each requestor may determine whether or not another resource has accessed or changed the resource. The apparatus 300 may therefore reduce instances of requestors waiting for access to a resource (e.g. a bottleneck). It will further be appreciated that the apparatus 300 of FIG. 3 may facilitate a transactional memory that is supported within a core chip (e.g. without external circuitry such as a cache, bus, or memory support).

Referring to FIG. 4, a particular embodiment of a computer-implemented method 400 is illustrated. The computer-implemented method 400 includes receiving a first VLIW packet that includes a pair of load-locked instructions, at 404, and executing the pair of load-locked instructions using a pair of address reservation registers, at 408. For example, referring to FIG. 1, the first VLIW packet 101 may include a pair of load-locked instructions to be executed. As a further example, the pair of load-locked instructions may be executed using a pair of address reservation registers 204 and 304 within the load/store units 118 and 120. Although not required, the pair of load-locked instructions may be atomically linked (e.g. executed in parallel or substantially in parallel).

The method 400 further includes receiving a second VLIW packet that includes a second pair of instructions to be executed atomically, where at least one of the second pair of instructions is a store-conditional instruction, at 412. As an example, a second pair of store-conditional instructions may be the SC(Data) and SC(WriteIndex+1) instructions executed by one of the threads or processors, as shown at 303 and 305.

The method 400 further includes determining whether an address reservation register is valid, at 416. For example, a status bit within an address reservation register corresponding to the at least one store-conditional instruction may be evaluated by the testing logic module 124 of the apparatus 100 of FIG. 1.

When the address reservation register is determined to not be valid, an indication of execution failure of the store-conditional instruction may be provided, at 422, and execution of the pair of load-locked instructions may be retried (e.g. by returning to execution step 408). For example, if either instruction of the second pair of instructions is determined to have failed, then both of the instructions of the second pair of instructions are deemed to have failed (e.g. neither instruction of the second pair of instructions is committed).

When the address reservation register is determined to be valid, an indication of execution success of the store-conditional instruction may be provided, at 418, and at least one memory location may be updated with data corresponding to the store-conditional instruction, as shown at 420. For example, the testing logic 124 may determine that a successful operation occurred and may write an output of the store-conditional operation to the general register(s) 126 of FIG. 1. As a further example, a result of executing a store-conditional instruction may be written to the FIFO Buffer 370, as shown in FIG. 3. According to a particular embodiment, the second pair of instructions further includes a second store-conditional instruction and updating the at least one memory location further includes updating a memory location corresponding to the second store-conditional instruction (e.g. both of the store-conditional instructions are committed in response to determining success of both of the store-conditional instructions).

The computer-implemented method 400 includes executing a program that includes a transactional memory operation. The transactional memory operation may include instructions to be atomically executed (e.g. the instructions either succeed or fail as a single atomic unit). For example, a transactional memory operation that is atomically executed may include a load-modify-store sequence, as described herein with reference to FIG. 3. That is, if the load-modify-store sequence is to be atomically executed, then either the entire load-modify-store sequence fails or the entire load-modify-store sequence succeeds. The entire load-modify-store sequence may be retried in response to failure of the entire load-modify-store sequence.

The transactional memory operation may include operations that are atomically linked (e.g. executed in parallel or substantially in parallel). First and second memory operations that are atomically linked may packetized together or grouped in a common packet. The first and second memory operations that are atomically linked may be a pair of load-locked operations or a pair of store-conditional operations. An example of an atomically linked pair of store-conditional operations is shown by the pair of store conditional operations 382 of the executable program 303 of FIG. 3.

In a particular embodiment, a first load-modify-store sequence and a second load-modify-store sequence are atomically executed (e.g. if either sequence fails then both sequences are deemed to have failed). An example of a pair of atomically executed load-modify-store operations is illustrated by execution of the executable program 303 of FIG. 3 (i.e. a load-modify-store sequence corresponding to the FIFO buffer 370 and a load-modify-store sequence corresponding to the WriteIndex 360).

The first and second memory operations may be atomically executed by a single very long instruction word (VLIW) packet at a VLIW processor. For example, the processor within the apparatus 100 may execute the store-conditional instruction 103 and the load or store instruction 104 within the VLIW instruction packet 101 of FIG. 1 as described herein. The VLIW processor may be configured to determine that first and second memory locations corresponding to the first and second memory operations should be updated atomically (e.g. that a data entry of the FIFO buffer 370 and the WriteIndex value 364 of FIG. 3 should be updated atomically).

In a particular illustrative embodiment, the first memory operation includes reading data at a first memory location of the VLIW processor and the second memory operation includes reading data at a second memory location of the VLIW processor. In a further example, a data element within the FIFO buffer may be read and a WriteIndex value of the WriteIndex may be read. In another illustrative embodiment, the first memory operation includes a store operation corresponding to a first memory location of the VLIW processor and a second memory operation includes a store operation corresponding to a second memory location of the VLIW processor. In a particular illustrative embodiment, the first memory location is location within the FIFO buffer 370 and the second memory location is the WriteIndex value 364 of FIG. 3. In a particular illustrative embodiment, one or more of the store operations is a store-conditional operation.

In a particular illustrative embodiment, the operation at the first memory location is a store-conditional operation and the operation at the second memory location is a non-conditional store instruction. Thus, both store-conditional and non-conditional instructions may be executed and may update the memory.

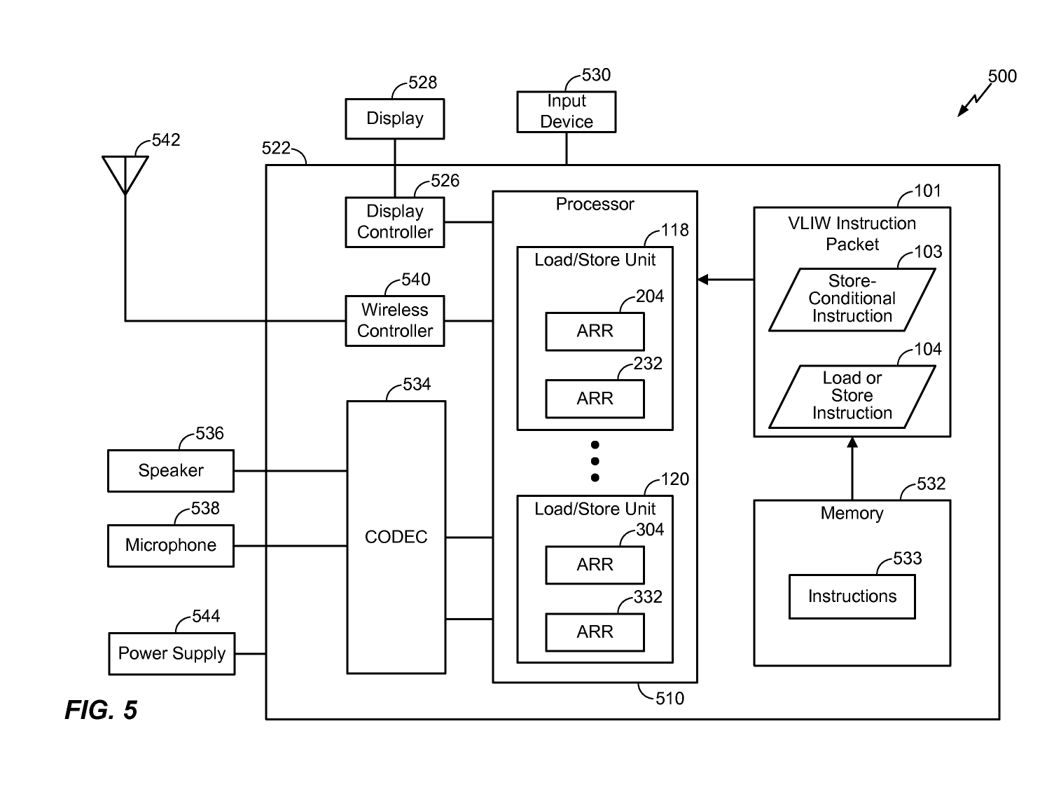

Referring to FIG. 5, a block diagram of a particular illustrative embodiment of an electronic device including a processor 510 that includes the first load/store unit 118 and the second load/store unit 120 of the apparatus 100 of FIG. 1 is depicted and generally designated 500. The electronic device 500 further may include elements described with reference to FIGS. 1-3, may operate according to the method of FIG. 4, or any combination thereof.

The first load/store unit 118 may include the first address reservation register (ARR) 204 and the second ARR 232. The second load/store unit 120 may include the third ARR 304 and the fourth ARR 332. More than two load/store units may be provided.

The processor 510 may be coupled to a memory 532. The memory 532 may include instructions 533 to be executed by the processor 510. For example, the instructions 533 may include the VLIW instruction packet 101 that includes the store-conditional instruction 103 and the load or store instruction 104 of FIG. 1.

FIG. 5 also shows a display controller 526 that is coupled to the processor 510 and to a display 528. A coder/decoder (CODEC) 534 can also be coupled to the processor 510. A speaker 536 and a microphone 538 can be coupled to the CODEC 534.

FIG. 5 also indicates that a wireless controller 540 can be coupled to the processor 510 and to a wireless antenna 542. In a particular embodiment, the processor 510, the display controller 526, the memory 532, the CODEC 534, and the wireless controller 540 are included in a system-in-package or system-on-chip device 522. In a particular embodiment, an input device 530 and a power supply 544 are coupled to the system-on-chip device 522. Moreover, in a particular embodiment, as illustrated in FIG. 5, the display 528, the input device 530, the speaker 536, the microphone 538, the wireless antenna 542, and the power supply 544 are external to the system-on-chip device 522. However, each of the display 528, the input device 530, the speaker 536, the microphone 538, the wireless antenna 542, and the power supply 544 can be coupled to a component of the system-on-chip device 522, such as an interface or a controller.

Those of skill would further appreciate that the various illustrative logical blocks, configurations, modules, circuits, and algorithm steps described in connection with the embodiments disclosed herein may be implemented as electronic hardware, computer software, or combinations of both. Various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary non-transitory (e.g. tangible) storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. An apparatus comprising:
a very long instruction word (VLIW) processor operable to execute VLIW instructions, at least one of the VLIW instructions including a first load or store instruction and a second load or store instruction, wherein the first instruction and the second instruction are executed as a single atomic unit, wherein at least one of the first and second instructions is a store-conditional instruction.

2. The apparatus of claim 1, wherein the store-conditional instruction commits only if a valid bit stored at an address reservation register corresponding to the store-conditional instruction is determined to be valid.

3. The apparatus of claim 2, wherein the address reservation register is configured to store a reserved address associated with the store-conditional instruction.

4. The apparatus of claim 1, wherein the execution of the store-conditional instruction is configured to provide one of an indication of execution success and an indication of execution failure.

5. The apparatus of claim 4, wherein in response to the indication of execution success, at least one memory location of the VLIW processor is updated with data corresponding to the store-conditional instruction, and wherein in response to the indication of execution failure, the at least one memory location of the VLIW processor is not updated with the data corresponding to the store-conditional instruction.

6. The apparatus of claim 5, wherein the at least one memory location of the VLIW processor includes an entry of a first-in first-out (FIFO) buffer and a write index corresponding to the entry of the FIFO buffer.

7. The apparatus of claim 5, wherein the VLIW processor is configured to retry execution of the at least one VLIW instruction in response to the indication of execution failure.

8. The apparatus of claim 1, wherein atomically executing the first and second instructions as a single atomic unit comprises determining either that both the first and second instructions have succeeded or that both the first and second instructions have failed.

9. A computer-implemented method comprising executing a program that includes a transactional memory operation, the transactional memory operation including a first memory operation atomically linked to a second memory operation, wherein the first and second memory operations are executed by a single very long instruction word (VLIW) packet at a VLIW processor.

10. The computer-implemented method of claim 9, wherein the first memory operation includes reading data at a first memory location of the VLIW processor, and wherein the second memory operation includes reading data at a second memory location of the VLIW processor.

11. The computer-implemented method of claim 10, wherein reading the data at the first memory location and reading the data at the second memory location are performed via a pair of load-locked instructions.

12. The computer-implemented method of claim 9, wherein the first memory operation includes a store operation corresponding to a first memory location of the VLIW processor, and wherein the second memory operation includes a store operation corresponding to a second memory location of the VLIW processor.

13. The computer-implemented method of claim 12, wherein the store operation at the first memory location is a store-conditional operation.

14. The computer-implemented method of claim 13, wherein the store operation at the second memory location is a non-conditional store instruction.

15. The computer-implemented method of claim 13, wherein executing the program further comprises determining whether the store-conditional instruction succeeds.

16. The computer-implemented method of claim 9, wherein executing the program further comprises determining that a first memory location of the VLIW processor corresponding to the first operation and a second memory location of the VLIW processor corresponding to the second operation should be updated atomically.

17. An apparatus comprising:
a multi-threaded processor including a load/store unit, the load/store unit including multiple address reservation registers assigned to each thread, each of the address reservation registers to store a reserved address associated with a load-locked store-conditional pair of operations.

18. The apparatus of claim 17, wherein the multi-threaded processor is one of a plurality of processors in a multiple processor architecture, and wherein each of the processors includes multiple address reservation registers.

19. The apparatus of claim 18, wherein checking the address reservation register prior to completing the load-locked store-conditional pair of operations comprises determining whether data corresponding to the one of the address reservation registers has changed.

20. The apparatus of claim 19, wherein the load-locked store-conditional pair of operations fails in response to determining that the data corresponding to only the one of the address reservation registers has changed.

21. An apparatus comprising:
means for executing very long instruction word (VLIW) instructions, wherein at least one of the VLIW instructions includes a first load or store instruction and a second load or store instruction, wherein the first instruction and the second instruction are atomically executed as a single atomic unit, wherein at least one of the first and second instructions is a store-conditional instruction; and
means for storing data, wherein the means for storing data is responsive to the means for executing VLIW instructions.

22. The apparatus of claim 21, wherein the means for executing VLIW instructions comprises a VLIW processor.

23. The apparatus of claim 22, wherein the VLIW processor is a multithreaded VLIW processor, and wherein each of the multiple threads of the multithreaded VLIW processor is assigned to multiple address reservation registers.

24. The apparatus of claim 21, wherein the means for storing data comprises a first-in first-out (FIFO) buffer and a write index.

25. The apparatus of claim 21, wherein atomically executing the first and second instructions comprises generating at least one output that indicates success or failure associated with the store-conditional instruction.

26. The apparatus of claim 25, wherein the means for executing VLIW instructions is configured to update data at the means for storing data in response to the at least one output indicating success.

27. A computer-readable tangible medium storing instructions executable by a computer to execute a program that includes a transactional memory operation, the transactional memory operation including a first memory operation atomically linked to a second memory operation, wherein the first and second memory operations are executed by a single very long instruction word (VLIW) packet at a VLIW processor.

28. The computer-readable tangible medium of claim 27, wherein the first memory operation and the second memory operation are executed substantially in parallel via respective first and second load/store units.

29. The computer-readable tangible medium of claim 28, wherein the first and second memory operations are store-conditional memory operations.

30. An apparatus, comprising:
a very long instruction word (VLIW) processor including:
a buffer including a plurality of data entries;
a write index operable to selectively point to each of the plurality of data entries; and
a load/store unit operable to execute a pair of load-locked operations as a single atomic unit and further operable to execute a pair of store-conditional operations as a single atomic unit.

31. The apparatus of claim 30, wherein executing the pair of load-locked operations comprises reading first values at one of the data entries and at the write index, and wherein executing the pair of store-conditional instructions comprises storing second values at the one data entry and at the write index.

32. The apparatus of claim 31, further comprising logic to determine whether the first values have been altered subsequent to executing the pair of load-locked operations.

33. The apparatus of claim 32, further comprising a plurality of address reservations registers, wherein the address reservation registers are configured to store a reserved address and a valid bit that are each associated with the pair of load-locked operations.

34. The apparatus of claim 30, wherein the VLIW processor is operable to atomically execute a pair of load-modify-write operations via the pair of load-locked operations and the pair of store-conditional instructions.
